(19) United States
(12) Patent Application Publication
(10) Pub. No.: US 2014/0034333 A1
(43) Pub. Date: Feb. 6, 2014

(54) LIFTING DEVICE AND METHOD

(71) Applicant: James Mata, Burleson, TX (US)

(72) Inventor: James Mata, Burleson, TX (US)

(21) Appl. No.: 13/567,531

(22) Filed: Aug. 6, 2012

(51) Int. Cl. E21B 33/06; B66D 1/26

(52) U.S. Cl. 166/378; 254/278

(57) ABSTRACT

A lifting device and method comprising a plurality of units removably coupled together. Each unit comprises a housing and a winch. The housing of each unit further comprises forward and rearward housing portions, each of said portions further comprising one or more top, bottom, side, and rear plates. The winch and support members span between and within the forward and rearward housing portions.

### BACKGROUND OF THE INVENTION

1. Field of the Invention

The invention relates generally to a lifting device and specifically to methods and apparatus for lifting a blowout preventer.

2. Description of the Prior Art

Blowout preventers are used in oil and gas drilling and production operations as safety devices. Generally, a blowout preventer is structured and arranged so as to be capable of closing, isolating, and sealing a wellbore in the event certain pressure thresholds are met or exceeded. In their simplest forms, blowout preventers are large valves connected to the wellhead which, when closed, prevent the release of high-pressure gas or liquids from the well. There are several types of conventional and commercially available blowout preventers, including a ram-type which uses two opposing closure members, or rams, which, when closed prohibit flow through the bore. The rams may be pipe rams, which are configured to close and seal an annulus around a pipe disposed within the bore, or blind rams or shearing blind rams, configured to close and seal the entire bore. A variety of pipe rams and blind rams can be used depending upon the particular drilling requirements. Such variety of blowout preventers may be assembled into a multiple blowout preventer stack comprising, for example, a plurality of ram-type blowout preventers, each equipped with a specific ram type. The term “blowout preventer”, as used in this specification shall generally refer to a single blowout preventer, a blowout preventer stack, as well as an assembly of blowout preventers and/or other parts that may be mounted on or near the wellhead and which collectively function to prevent blowouts.

Most blowout preventers are coupled to a fluid pump or some other active source of pressurized hydraulic fluid. Others may use pressurized fluid stored in the stack assembly. Since oil and gas drilling operations inherently involve high pressure, blowout preventer stack assemblies are large in diameter and may weigh many thousands of pounds.

Assembling and positioning the blowout preventer on the wellhead can be time consuming and dangerous. The process requires taking each individual part of the blowout preventer and mounting such part together with an adjacent portion to form a complete blowout preventer. Each individual part can weigh several thousand pounds. The complete blowout preventer is then moved from the assembly area to a position beneath the rig floor over the wellhead.

Conventional and commercially available lifting devices are largely inadequate for moving an assembled blowout preventer to a position over the wellhead. What is needed is an improved blowout preventer lifting device which is safe and efficient and which permits oil and gas drilling workers to quickly and safely assemble a blowout preventer and place the blowout preventer in a position over the wellhead.

### SUMMARY OF THE INVENTION

The present invention provides a lifting device which is safe and efficient and which permits oil and gas drilling workers to quickly and safely assemble a blowout preventer and place the blowout preventer in a position over the wellhead. In the preferred embodiment, the blowout preventer lifting device of the present invention comprises a plurality of units removably coupled together. Each unit comprises a housing and a winch. The housing of each unit further comprises forward and rearward housing portions, each of said portions further comprising one or more top, bottom, side, and rear plates. The winches are each secured to support members, the winch and support members spanning between and within the forward and rearward housing portions. In one embodiment, the housing front plate is coupled to the top plate and two side plates. A ledge plate portion spans at a lower position and is coupled to the side portions. A vertical receiver housing spans between the ledge plate and the front plate. A top side of each unit of the lifting device is generally open except for one or more horizontal support members which span between the forward and rearward housing portions. In one embodiment, one of said horizontal support members is @O′ elongated pipe and spans between each unit's forward and rearward housing portions at a position just below a top surface of the device. In one embodiment, one of said horizontal support members is an elongated solid member that spans between the forward and rearward housing portions and is secured to the top surface of the device. In one embodiment, one of the horizontal support members comprises a pad eye for use in permitting the device to be lifted with a winch or hooked cable.

The vertical receiver portion is structured and arranged to be capable of receiving a joining member. The joining member permits one unit of the device to be coupled to another unit such that two or more units may be used to form the lifting device. In the preferred embodiment, two units are removably coupled to form the lifting device. In this embodiment, four joining members are used to couple the two units together. The joining members have openings which may be used to insert pins to secure the units to vertical receiver portions having pin openings.

In this embodiment, there are four vertical receiver portions, each being mounted on a different portion of each unit's housing. In one embodiment, two vertical receiver portions are mounted on the fronts of two units and two vertical receiver portions are mounted on the backs of the two units. An upper front joining member is inserted within the front vertical receiver portions in an upper position and a lower front joining member is inserted within the front vertical receiver portions in a lower position. An upper back joining member is inserted within the back vertical receiver portions in an upper position and a lower back joining member is inserted within the back vertical receiver portions in a lower position.

In one embodiment, the device comprises chains. In this embodiment, the chains are coupled at one end to a housing plate at a position near where the joining member will be secured to the vertical receiver.

In one embodiment, the device comprises a plurality of storage posts. In this embodiment, each storage post is coupled at one end to a portion of the upper housing plate. When the devices are not coupled together, the joining members may be stored on these posts.

The two units, with the respective joining members in place, are secured to one another and capable of lifting an object such as a blowout preventer. The winches, which span between the forward and rearward housing portions, each comprise a cable. This cable may be suspended between the forward and rearward housing portions and between the two units.

The device may be positioned on the floor of a rig. The cable or cables may be lowered beneath the rig floor and removably coupled to a blowout preventer or blowout preventer stack, which blowout preventer or blowout preventer stack may be lifted to either be placed in position or removed from a wellhead.

In one embodiment, the device comprises a single unit. In other embodiments, the device comprises three or more units.

Although in the preferred embodiment, the device is intended for use in lifting a blowout preventer, the device may be used in other applications and may be used, for example, to lift other objects and equipment either below the position of the device, or when used in connection with a system of pulleys, above the device.

The present invention also provides a method of installing a blowout preventer. The method comprises the steps of providing a lifting device comprising first and second winches, said first winch being coupled to a first support base and said second winch being coupled to a second support base; said first and second support bases being coupled to one another; positioning the lifting device on a drilling platform; securing one or more winch cables to a portion of the blowout preventer; lifting the blowout preventer with the one or more winches; positioning the blowout preventer on a wellhead; coupling the blowout preventer to the wellhead; and removing the one or more cable from the blowout preventer.

In another embodiment, the method of installing a blowout preventer generally comprises providing a lifting device comprising a plurality of units, each such unit comprising a housing comprising a winch, the housing further comprising forward and rearward housing portions, each of said portions further comprising one or more top, bottom, side, and rear plates; the winch being secured to support members, the winch and support members spanning between and within the forward and rearward housing portions of each unit; positioning the lifting device on a drilling platform; securing one or more winch cables to a portion of the blowout preventer; lifting the blowout preventer with the winches; positioning the blowout preventer on the wellhead; coupling the blowout preventer on the wellhead; and removing the one or more cable from the blowout preventer.

The present invention also provides a method of removing a blowout preventer from a wellhead. The method comprises the steps of providing a lifting device comprising first and second winches, said first winch being coupled to a first support base and said second winch being coupled to a second support base; said first and second support bases being coupled to one another; positioning the lifting device on a drilling platform; securing one or more winch cables to a portion of the blowout preventer; decoupling the blowout preventer from a wellhead; lifting the blowout preventer with the one or more winches; positioning the blowout preventer away from the wellhead; and removing the one or more cables from the blowout preventer.

In another embodiment, the method of removing a blowout preventer generally comprises providing a lifting device comprising a plurality of units, each such unit comprising a housing comprising a winch, the housing further comprising forward and rearward housing portions, each of said portions further comprising one or more upper, lower, side, front and rear plates; the winch being secured to support members, the winch and support members spanning between and within the forward and rearward housing portions; positioning the lifting device on a drilling platform; decoupling the blowout preventer from the wellhead; securing one or more winch cables to a portion of the blowout preventer; lifting the blowout preventer with the winches; positioning the blowout preventer away from the wellhead; and removing the one or more cables from the blowout preventer.

### BRIEF DESCRIPTION OF THE DRAWINGS

FIG. 1 is a front, top, and right side isometric view of the lifting device in accordance with a preferred embodiment.

FIG. 2 is a left side elevation view of the lifting device in accordance with a preferred embodiment.

FIG. 3 is a back, top, and right side isometric view of the lifting device in accordance with a preferred embodiment.

FIG. 4 is a right side elevation view of the lifting device in accordance with a preferred embodiment.

FIG. 5 is an elevation view of a drilling rig showing the device resting on the rig floor.

### DESCRIPTION OF THE PREFERRED EMBODIMENT

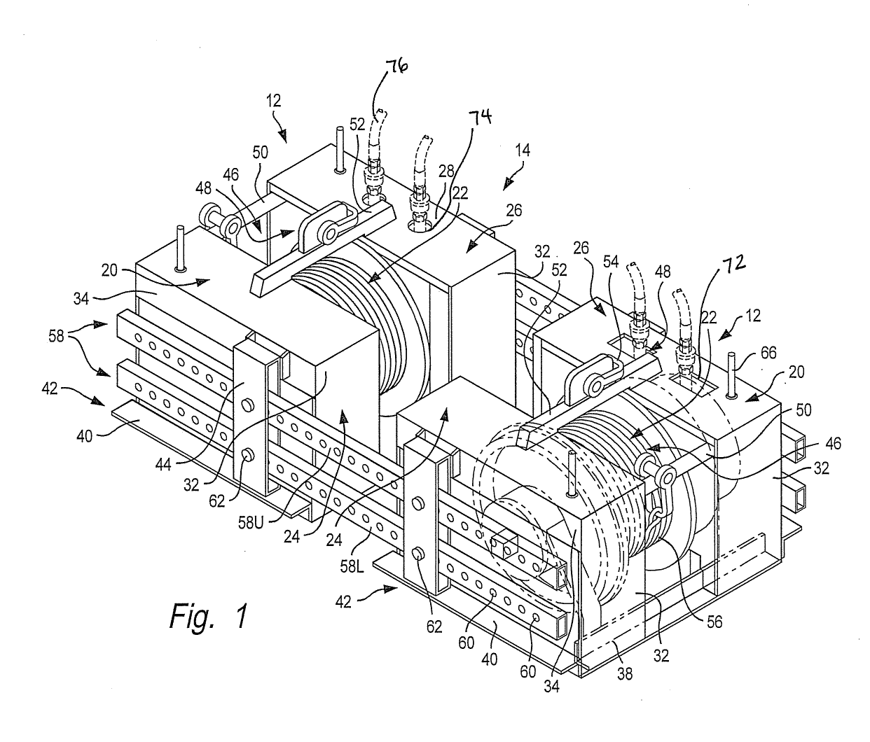

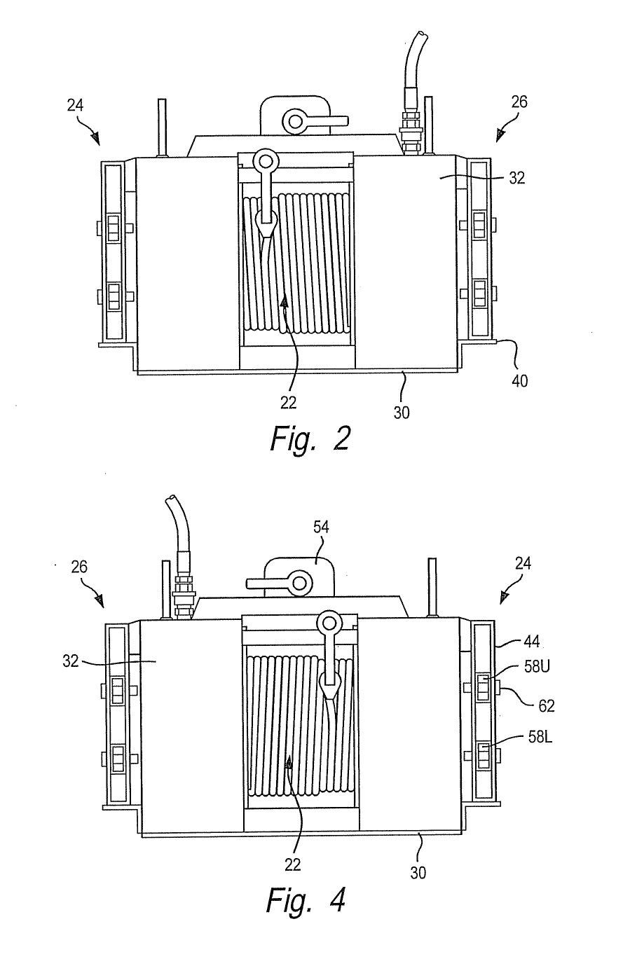

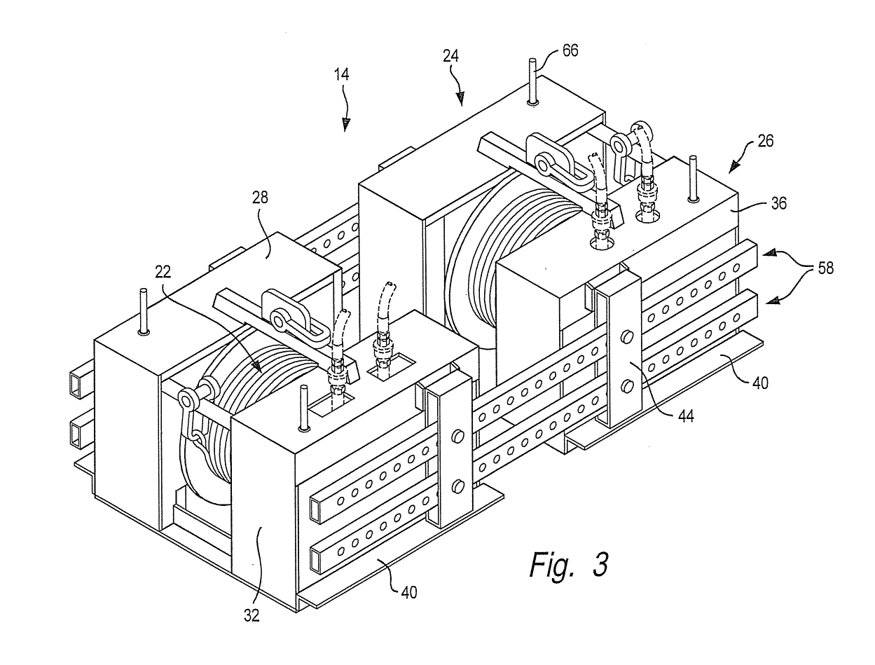

Referring to FIGS. 1-5, the present invention provides a lifting device 14 which is safe and efficient and which, among other applications, permits oil and gas drilling workers to quickly and safely assemble a blowout preventer 16 and place the blowout preventer 16 in a position over the wellhead 18 and safely disassemble a blowout preventer 16 and remove the blowout preventer 16 from the wellhead 18. In the preferred embodiment, the lifting device 14 of the present invention comprises a plurality of units 12, each unit 12 comprising a housing 20 and a winch 22.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment of the present disclosure. Thus, the appearances of such phrases in various places throughout this specification are not necessarily all referring to the same embodiment. Furthermore, the particular features, structures, or characteristics may be combined in any suitable manner on one or more embodiments without limitation.

As shown in FIGS. 1-4, the housing 20 of each unit 12 further comprises forward 24 and rearward 26 housing portions, each of said portions 24, 26 further comprising one or more upper 28, lower 30, side 32, front 34 and rear plates 36. In the preferred embodiment, these plates 28, 32, 24, 36 are formed from ½ to ⅜ inch steel plate material. However, any similarly strong material may be used without departing from the scope of the invention.

The winch 22 of each unit 12 is secured to support members 38. In the preferred embodiment, the winch 22 is a conventional and commercially available Ramsey brand 50,000 pound hydraulic winch 22. However, winches 22 of different lifting capacities can be used without departing from the scope of the invention. Referring to FIG. 1, each winch 22 and support members 38 span between and within each unit's 12 forward 24 and rearward 26 housing portions. The support members 38 are formed from ⅝ inch angle iron and extend from front to back of the unit 12.

In one embodiment, the housing front plate 34 is coupled to the upper plate 28 and two side plates 32.

As shown in FIGS. 1-4, the upper 28 plate comprises cutouts 74, 76 through which a winch 22 hydraulic hose 78 or other material 78 may be threaded.

A ledge plate 40 portion spans at a lower position 42 and is coupled to the side plates 32. In the preferred embodiment, the ledge plate 40 is formed from ⅝ inch angle iron. This ledge plate 40 is secured to the side plates 32, 32 and cross members/lower plates 30. In the preferred embodiment, the ledge plate 40 is secured to the side plates 32, 32 and support members 38 by a weld.

A vertical receiver portion 44 spans between the ledge plate 40 and the front plate 34. This vertical receiver portion 44 is formed from ¼ inch 2×2 steel tubing in the preferred embodiment, and is welded to the front plate 34 and an upper surface of the ledge plate 40.

A top side 46 of each unit 12 is generally open except for one or more horizontal support members 48 which span between the unit's 12 forward 24 and rearward housing 26 portions. In one embodiment, one of said horizontal support members 48 is an elongated pipe 50 and spans between the unit's 12 forward 24 and rearward housing 26 portions at a position just below a top surface 50 of the device 14. In one embodiment, one of said horizontal support members 48 is an elongated solid member 52 that spans between the unit's 12 forward 24 and rearward housing 26 portions and is secured to the top surface 50 of the unit 12. In one embodiment, one of the horizontal support members 48 comprises a pad eye 54 for use in permitting the device 14 to be lifted with a winch 22 comprising a hooked cable 56.

Each unit's 12 vertical receiver portion 44 is structured and arranged to be capable of receiving a joining member 58. The joining member 58 permits the unit 12 to be joined to another unit 12 such that two units 12 may be used in tandem with one another. In the preferred embodiment, the joining members 58 have openings 60 which may be used for insertion of a pin 62 to secure the unit 12 to vertical receiver portion 44 having corresponding pin openings 60. In this embodiment, there are four vertical receiver portions 44, each being mounted on a different portion of each unit's 12 housing 20. In one embodiment, two vertical receiver portions 44 are mounted on the front plates 34, 34 of two units 12 and two vertical receiver portions 44 are mounted on the rear plates 36 of the two units 12, 12. An upper front joining member 58U is inserted within the front vertical receiver portions 44 in an upper position and a lower front joining member 58L is inserted within the front vertical receiver portions 44 in a lower position. An upper rear joining member 58U is inserted within the rear vertical receiver portions 44 in an upper position and a lower rear joining member 58L is inserted within the rear vertical receiver portions 44 in a lower position.

Although in the preferred embodiment, the device 14 comprises two units 12, the device 14 need not be confined to such an arrangement. For example, in one embodiment, the device 14 comprises a single unit 12. In other embodiments, the device 14 may comprise three or more units 12.

In one embodiment, the device 14 comprises chains 64. In this embodiment, the chains 64 are coupled at one end to a housing plate 28, 30, 32, 34, 36, or 38 at a position near where the joining member 58 will be secured to the vertical receiver portion 44.

In one embodiment, the device 14 comprises a plurality of storage posts 66. In this embodiment, each storage post 66 is coupled at one end to a portion of each unit's 12 upper housing plate 28. When the units 12, 12 are not coupled together, the joining members 58 may be stored on these posts 66.

The two units 12, 12 with the respective joining members 58 in place, are secured to one another and capable of lifting an object 16 such as a blowout preventer 16. The winches 22, which span between the forward 24 and rearward housing portions 26 of each unit 12 each comprise a cable 56. This cable 56 may be suspended between the forward 24 and rearward housing 26 portions and between the two units 12, 12.

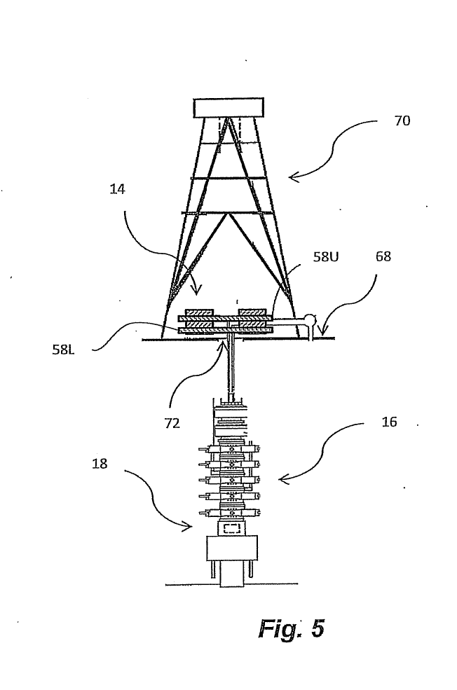

Referring to FIG. 5, the device 14 may be positioned on the floor 68 of a drilling rig 70. The cable 56 or cables 56 may be lowered beneath the rig floor 68 and removably coupled to a blowout preventer 16 or blowout preventer stack 16, which blowout preventer 16 or blowout preventer 16 stack may be lifted to either be placed in position or removed from a wellhead 18.

The operation and use of the lifting device 14 of the preferred embodiment will now be described. Each unit 12 of the lifting device 14 are lifted and positioned on the floor of a drilling platform 68 and placed around the drill floor opening 72 in a desired position such that the units 12, 12 are adequately spaced apart for the particular application. The units 12, 12 are coupled together by inserting the joining members 58U, 58L through the vertical receiver portions 44 and pins 62 are inserted to secure the units 12, 12 in the desired position. One or more winch 22 cables 56 are secured to a portion of the blowout preventer 16 and the blowout preventer 16 is lifted with the winches 22. The blowout preventer 16 is positioned on and coupled to the wellhead 18. The one or more cables 56 are then removed from the blowout preventer 16. The blowout preventer 16 can be removed by reversing the foregoing process.

The present also provides a method of installing a blowout preventer 16. The method of the present invention generally comprises providing a lifting device 14 comprising a plurality of units 12, each unit 12 comprising a housing 20 comprising a winch 22, the housing 20 further comprising forward 24 and rearward housing portions 26, each of said portions 24, 26 further comprising one or more upper 28, lower 30, side 32, front 34 and rear plates 36; the winch 22 being secured to support members 48, the winch 22 and support members 48 spanning between and within the forward 24 and rearward housing 26 portions; positioning the lifting device 14 on a drilling platform 68; securing one or more winch 22 cables 56 to a portion of the blowout preventer 16; lifting the blowout preventer 16 with the winches 22; positioning the blowout preventer 16 on the wellhead 18; coupling the blowout preventer 16 on the wellhead 18; and removing the one or more cables 56 from the blowout preventer 16.

The present invention also provides a method of removing a blowout preventer 16 from a wellhead 18. The method of the present invention generally comprises providing a of lifting device 14 comprising a plurality of units 12, each unit 12 comprising a housing 20 comprising a winch 22, the housing 20 further comprising forward 24 and rearward housing portions 26, each of said portions 24, 26 further comprising one or more upper 28, lower 30, side 32, front 34 and rear plates 36; the winch 22 being secured to support members 48, the winch 22 and support members 48 spanning between and within the forward 24 and rearward housing 26 portions; positioning the lifting device 14 on a drilling platform 68; securing one or more winch 22 cables 56 to a portion of the blowout preventer 16; decoupling the blowout preventer 16 from the wellhead 18; securing one or more winch 22 cables 56 to a portion of the blowout preventer 16; lifting the blowout preventer 16 with the one or more winches 22; positioning the blowout preventer 16 away from the wellhead 18; removing the one or more cables 56 from the blowout preventer 16.

Although in the preferred embodiment, the device 14 is intended for use in lifting a blowout preventer 16, the device 14 may be used to lift virtually any type of object either below the position of the device 14, or when used in connection with a system of pulleys, above the device 14.

While there has been illustrated and described what is, at present, considered to be a preferred embodiment of the present invention, it will be understood by those skilled in the art that various changes and modifications may be made, and equivalents may be substituted for elements thereof without departing from the true scope of the invention. Therefore, it is intended that this invention not be limited to the particular embodiment disclosed as the best mode contemplated for carrying out the invention, but that the invention will include all embodiments falling within the scope of the appended claims.

I claim:

1. A lifting device comprising first and second winches, said first winch being coupled to a first support base and said second winch being coupled to a second support base; said first and second support bases being coupled to one another.

2. The lifting device of claim 1 further comprising first and second winch housings, said first winch being positioned within said first winch housing, said second winch being confined within said second winch housing.

3. The lifting device of claim 1 further comprising first and second winch housings, said second winch being positioned within said second winch housing, said second winch being confined within said second winch housing.

4. The lifting device of claim 3, said first winch housing comprising forward and rearward housing portions.

5. The lifting device of claim 3, said second winch housing comprising forward and rearward housing portions.

6. The lifting device of claim 1, further comprising one or more joining members, said one or more joining members being removably coupled to said first and second support bases.

7. The lifting device of claim 6, said first and second support bases further comprising one or more receiver portions, each of said receiver portions adapted to receive one of said one or more joining members.

8. The lifting device of claim 1, further comprising a distance between said first and second support bases, and wherein said distance is adjustable.

9. The lifting device of claim 1, wherein the device is adapted for lifting a blowout preventer.

10. A method of installing a blowout preventer comprising the steps of:
providing a lifting device comprising first and second winches, said first winch being coupled to a first support base and said second winch being coupled to a second support base; said first and second support bases being coupled to one another;
positioning the lifting device on a drilling platform;
securing one or more winch cables to a portion of the blowout preventer;
lifting the blowout preventer with the one or more winches;
positioning the blowout preventer on a wellhead;
coupling the blowout preventer to the wellhead; and
removing the one or more cable from the blowout preventer.

11. A method of installing a blowout preventer comprising the steps of:
providing a lifting device comprising first and second winches, said first winch being coupled to a first support base and said second winch being coupled to a second support base; said first and second support bases being coupled to one another;
positioning the lifting device on a drilling platform;
securing one or more winch cables to a portion of the blowout preventer;
decoupling the blowout preventer from a wellhead;
lifting the blowout preventer with the one or more winches;
positioning the blowout preventer away from the wellhead; and
removing the one or more cables from the blowout preventer.
